(19) United States
(12) Patent Application Publication
(10) Pub. No.: US 2003/0217066 A1
(43) Pub. Date: Nov. 20, 2003

(54) System and methods for character string vector generation

(75) Inventor: Naoki Kayahara, Suwa-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/397,163

(22) Filed: Mar. 27, 2003

(30) Foreign Application Priority Data
Mar. 27, 2002 (JP) 2002-089812

(51) Int. Cl. G06F 7/00

(52) U.S. Cl. 707/100

(57) ABSTRACT

The invention provides a similarity calculation device which is well suited to effectively calculate the similarities of words in such a way that the words are impartially reflected on the calculation of the similarities in correspondence with their frequencies of occurrences. The invention can include first, document vectors that are generated on the basis of a plurality of document data. Each of the document vectors can have elements corresponding to respective morphemes, and each of the elements can be calculated so as to become a value conforming to the frequency of occurrences of the corresponding morpheme. Subsequently, word vectors are generated using the transposed matrix of a document word matrix in which the generated document vectors are gathered. Accordingly, each of the word vectors has elements corresponding to the respective document data, and each of the elements is generated so as to become a value which is proportional to the frequency of occurrences of the morpheme in the corresponding one of the plurality of document data and which is inversely proportional to the frequency of occurrences of the morpheme in the plurality of document data. Thereafter, the similarity of a word can be calculated on the basis of the word vector.

### BACKGROUND OF THE INVENTION

1. Field of Invention

The present invention relates to a device, a program, and a method which calculate the similarities of words. More particularly, the invention relates to a specified element vector generation device, a character string vector generation device, a similarity calculation device, a specified element vector generation program, a character string vector generation program, a similarity calculation program, a specified element vector generation method, a character string vector generation method, and a similarity calculation method which are well suited to effectively calculate the similarities of words in such a way that the words are impartially reflected on the calculation of the similarities in correspondence with their frequencies of occurrences.

2. Description of Related Art

A word relevance lexicon, thesaurus, or synonym dictionary can be created by two approaches, manual operations and automation. The former approach can offer an assured quality regarding a field to-be-handled, but it has the problems that similarities become out-of-date with the lapse of time, that man power necessitates a high cost, and that the creation covering various fields is difficult.

The latter approach can be accomplished by various techniques proposed and can create the lexicon or the like only in the presence of document sets in fields to-be-handled, but it is actually inferior in accuracy (quality) to the former approach. Recently, however, the effects of the automation are incalculable in such a manner that, even in a retrieval service on the Internet, when retrieval is performed by entering a retrieval keyword once, candidates for a keyword which is thought the optimum for the subsequent refinement are displayed. In general, also in a knowledge management or document management system, it is very effective as the function of supporting the activities of intellectual creation and from the viewpoint of knowledge management that relevant words can be mined from a certain word or sentence, separately from the function of retrieving documents.

Heretofore, as techniques for calculating the similarities of words by automation, there have been, for example, a document classification device (herein below, termed the “first example”) disclosed in Japanese Patent Laid-Open No. 7-114572, a method for quantizing the concept of a “word” (herein below, termed the “second example”) as disclosed in Japanese Patent Laid-Open No. 9-134360, and a retrieval method (hereinbelow, termed the “third example”) disclosed in a paper: Qiu, Y. & H. P. Frei (1993), “Concept Based Query Expansion”, Proc. of the 16th Annual Int. ACM SIGIR Conf. on R&D Information Retrieval, pp. 160-169.

The first example can include a storage unit which stores document data therein, a document analysis unit which analyzes document data, a word vector generation unit which automatically generates a feature vector expressive of the feature of each word by using the cooccurrence relationship among words in a document, a word vector storage unit which stores such feature vectors therein, a document vector generation unit which generates the feature vector of each document from the feature vectors of the words contained in the document, a document vector storage unit which stores such feature vectors of documents, a classification unit which classifies the documents by utilizing the similarities among the feature vectors of the documents, a result storage unit which stores classified results therein, and a feature vector generating dictionary in which words for use in the feature vector generation are registered. Thus, the feature vectors of the words are automatically extracted from the documents, and the documents are classified on the basis of the feature vectors, thereby to realize the automatic classification which uses semantic differences.

The second example is a method for quantizing the concept of each “word” used in a document. The method can include the step of analyzing the given document, thereby to extract one or more “relational words” which are in the relation of forming a grammatical set together with the “word”, and the step of evaluating a “coupling degree” which the “word” has with respect to each of the “relational words”, whereby the concept of the “word” is quantized in the form of the “coupling degree(s)” with respect to one or more “relational words” in the relation of forming the grammatical set together with the “word.” Thus, the method is well suited to generate the similarities among words and can quantize the concept of the word.

The third example is such that a plurality of document data are analyzed by a morpheme analysis, that a word vector is generated by DFITF (Document Frequency & Inverse Term Frequency) every morpheme obtained, and that similarities are calculated on the basis of such word vectors generated. The word vector has elements corresponding to each document data, and each element has a value calculated by the DFITF for the word corresponding to the word vector. The DFITF is evaluated as the product between the frequency of document data in which the word is used in all the document data (DF: Document Frequency) and the inverse number of the frequency of occurrences of the word in the single document data (ITF: Inverse Term Frequency).

### SUMMARY OF THE INVENTION

In the first example, however, word vectors are generated using statistical information based on the numbers of times of multiple occurrences of words in a document set, and hence, that one of the elements of the word vectors which corresponds to any word being high in the frequency of occurrences (termed the “word of high frequency of occurrences” below) comes to have a prominently large value as compared with the other elements. Accordingly, regarding any word whose frequency of occurrences is low (termed the “word of low frequency of occurrences” below), the corresponding element becomes a relatively small value on the order of an error. In case of employing such word vectors for the calculation of similarities, therefore, there has been the problem that the word of low frequency of occurrences is difficult to be reflected on a retrieval result. Besides, in the above first example, words to-be-handled are limited by employing the dictionary of words to-be-registered, in order that the element corresponding to the word of high frequency of occurrences may be prevented from becoming the prominently large value. In general, the employment of a dictionary leads to a method which requires a high cost for maintenance, and it is difficult of practical use for a general-purpose system which does not specify document sets to-be-handled.

Also, in the above second example, word vectors are generated using statistical information based on the numbers of times of cooccurrences of words in a document set. As in the first example, therefore, the problem that the word of low frequency of occurrences is difficult to be reflected on a retrieval result has been involved in case of employing such word vectors for the calculation of similarities.

Besides, in the third example, the word vector is generated by the DFITF. However, the paper does not state if the similarity of the word can be effectively calculated in accordance with the index, and the effect of the index is not clear.

Therefore, the present invention has been made with note taken of such unsolved problems involved in the prior techniques, and it has for an object to provide a specified element vector generation device, a character string vector generation device, a similarity calculation device, a specified element vector generation program, a character string vector generation program, a similarity calculation program, a specified element vector generation method, a character string vector generation method, and a similarity calculation method which are well suited to effectively calculate the similarities of words in such a way that the words are impartially reflected on the calculation of the similarities in correspondence with their frequencies of occurrences.

A specified element vector generation device of the invention can include a device wherein a specified element vector indicating a feature of a specified element is generated on the basis of a plurality of data, further including specified element vector generation component that generates the specified element vector on the basis of the plurality of data. The specified element vector can have elements corresponding to the respective data, and each of said elements can have a value which is proportional to a frequency of occurrences of said specified element in the corresponding one of the plurality of data and which is inversely proportional to a frequency of occurrences of the specified element in said plurality of data.

With such structure, the specified request vector can be generated on the basis of the plurality of data by the specified request vector generation component. The specified request vector has the elements corresponding to the respective data, and each of the elements is generated so as to become the value which is proportional to the frequency of occurrences of the specified element in the corresponding one of the plurality of data and which is inversely proportional to the frequency of occurrences of the specified element in the plurality of data.

Here, the specified element is an element which can be contained in data. By way of example, when the data is document data, a morpheme or a character string extracted from the document data in accordance with a predetermined rule corresponds to the specified element. The latter can be applied to a case of generating the specified element vector of the character string extracted by, for example, an n-gram method. Incidentally, even when the data is the document data, the specified element shall not be restricted to the morpheme or the character string extracted in accordance with the predetermined rule. The same holds true of a similarity calculation device, a specified element vector generation program, a similarity calculation program, a specified element vector generation method, and a similarity calculation method of invention, described below.

Besides, the data shall include image data, music data, or data of any other type in addition to the document data. The same holds true of the similarity calculation device, specified element vector generation program, similarity calculation program of invention, specified element vector generation method, and similarity calculation method, as described below.

Besides, the specified element vector generation component may have any structure as long as it is adapted to generate the specified element vector on the basis of the plurality of data. By way of example, the generation component may directly generate the specified element vector from the plurality of data, or it may well generate an intermediate product (for example, another vector) from the plurality of data and then generate the specified element vector from the generated intermediate product. The same holds true of the specified element vector generation program, and the specified element vector generation method described below.

Meanwhile, a character string vector generation device of the present invention, can include a device wherein a character string vector indicating a feature of a specified character string is generated on the basis of a plurality of document data. The device can further include character string vector generation component that generates the character string vector on the basis of the plurality of document data. The character string vector can have elements corresponding to the respective document data, and each of said elements can have a value which is proportional to a frequency of occurrences of said specified character string in the corresponding one of said plurality of document data and which is inversely proportional to a frequency of occurrences of said specified character string in said plurality of document data.

With such structure, the character string vector is generated on the basis of the plurality of document data by the character string vector generation device. The character string vector has the elements corresponding to the respective document data, and each of the elements is generated so as to become the value which is proportional to the frequency of occurrences of the specified character string in the corresponding one of the plurality of document data and which is inversely proportional to the frequency of occurrences of the specified character string in the plurality of document data.

Here, the character string vector generation component may have any structure as long as it is adapted to generate the character string vector on the basis of the plurality of document data. By way of example, the generation component may directly generate the character string vector from the plurality of document data, or it may well generate an intermediate product (for example, another vector) from the plurality of document data and then generate the character string vector from the generated intermediate product. The same holds true of a character string vector generation program, and a character string vector generation method, described below.

Further, in the character string vector generation device of the present invention, specified character string can be either of a morpheme obtained by a morpheme analysis and a character string extracted in accordance with a predetermined rule.

With such structure, the character string vector can be generated on the basis of the plurality of document data by the character string vector generation device. The character string vector has the elements corresponding to the respective document data, and each of the elements is generated so as to become the value which is proportional to the frequency of occurrences of the specified morpheme or the extracted character string in the corresponding one of the plurality of document data and which is inversely proportional to the frequency of occurrences of the specified morpheme or the extracted character string in the plurality of document data.

Further, a character string vector generation device of the invention can include a document vector generation component that generates document vectors for the respective document data. The document vector can have at least one element corresponding to said specified character string, and said element can have a value which is proportional to the frequency of occurrences of said specified character string in said document data and which is inversely proportional to the frequency of occurrences of said specified character string in said plurality of document data. The character string vector generation component generates said character string vector on the basis of the document vectors generated by said document vector generation device.

With such structure, the document vectors are generated for the respective document data by the document vector generation component. The document vector has at least one element corresponding to the specified character string, and the element is generated so as to have a value which is proportional to the frequency of occurrences of the specified character string in the pertinent document data and which is inversely proportional to the frequency of occurrences of the specified character string in the plurality of document data. Besides, the character string vector is generated on the basis of the generated document vectors by the character string vector generation component.

Further, a character string vector generation device of the invention can include a document data storage component that stores said plurality of document data, and character string analysis device for subjecting the document data of said document data storage component to a character string analysis. The document vector generation component calculates every character string obtained by the analysis of said character string analysis device, a first frequency of occurrences of the pertinent character string in said document data and a second frequency of occurrences of said pertinent character string in said plurality of document data, it generates as said document vector, a vector which has an element of a value being proportional to the calculated first frequency of occurrences and being inversely proportional to the calculated second frequency of occurrences, and it generates said document vector for all the document data of said document data storage device.

With such structure, the document data of the document data storage component are subjected to the character string analysis by the character string analysis means. The first frequency of occurrences of the pertinent character string in the document data and the second frequency of occurrences of the pertinent character string in the plurality of document data are calculated every character string obtained by the character string analysis, and the vector which has the element of the value being proportional to the calculated first frequency of occurrences and being inversely proportional to the calculated second frequency of occurrences is generated as the document vector, by the document vector generation component. The generation of the document vectors is performed for all the document data of the document data storage device.

Here, the document data storage device can store the document data by any device and at any time. It may store the document data beforehand, or it may well store the document data by external inputs during the operation of this device without storing them beforehand. The same holds true of a character string vector generation device, described below.

Further, the character string vector generation device of the invention can further include a document data storage component that stores the said plurality of document data. The document data includes an analytical result of character strings contained in said document data or consists of a single character string, and the document vector generation device calculates every character contained in said document data, a first frequency of occurrences of the pertinent character string in said document data and a second frequency of occurrences of said pertinent character string in said plurality of document data, it generates as said document vector, a vector which has an element of a value being proportional to the calculated first frequency of occurrences and being inversely proportional to the calculated second frequency of occurrences, and it generates said document vector for all the document data of said document data storage component.

With such structure, owing to the document vector generation component, the first frequency of occurrences of the pertinent character string in the corresponding document data and the second frequency of occurrences of the pertinent character string in the plurality of document data are calculated every character string contained in the document data, and the vector which has the element of the value being proportional to the calculated first frequency of occurrences and being inversely proportional to the calculated second frequency of occurrences is generated as the document vector. The generation of the document vectors is performed for all the document data of the document data storage component.

Further, a character string vector generation device of the present invention can include that the character string vector generation component forms a document word matrix in which the document vectors generated by said document vector generation component are gathered so as to set components of said document vectors as either of rows and columns, that it extracts components of the other of the rows and columns of the document word matrix from said document word matrix, and that it generates a vector of the extracted components as said character string vector.

With such structure, owing to the character string vector generation component, the document word matrix in which the generated document vectors are gathered so as to set components of the document vectors as either of rows and columns is formed, components of the other of the rows and columns of the document word matrix are extracted from the document word matrix, and a vector of the extracted components is generated as the character string vector.

Further, the character string vector generation device of the invention including a character string vector storage component that stores such character string vectors. The character string vector generation component stores the generated character string vector in said character string vector storage device. With such structure, the generated character string vector is stored in the character string vector storage device by the character string vector generation device.

Here, the character string vector storage component can store the character string vectors by any component and at any time. It may store the character string vectors beforehand, or it may well store the character string vectors by external inputs during the operation of this device without storing them beforehand. The same holds true of a similarity calculation device, a similarity calculation program, and a similarity calculation method, described below.

Meanwhile, a similarity calculation device of the invention can include a device wherein a similarity to a specified element is calculated on the basis of a specified element vector indicating a feature of the specified element. The device can further include a specified element vector storage component that stores the specified element vector, a data-for-decision input component for inputting data-for-decision containing a specified element for similarity decision, a specified element vector generation component for generating said specified element vector on the basis of the data-for-decision inputted by said data-for-decision input component, and a similarity calculation for calculating said similarity on the basis of said specified element vector generated by said specified element vector generation component and said specified element vector of said specified element vector storage component. The specified element vector has elements corresponding to the respective plurality of data, and each of said elements has a value which is proportional to a frequency of occurrences of said specified element in the corresponding one of said plurality of data and which is inversely proportional to a frequency of occurrences of said specified element in said plurality of data.

With such structure, when the data-for-decision is inputted from the data-for-decision input component, the specified element vector is generated on the basis of the inputted data-for-decision by the specified element vector generation component. The specified element vector has the elements corresponding to the respective data, and each of the elements is generated so as to become the value which is proportional to the frequency of occurrences of the specified element in the corresponding one of the plurality of data and which is inversely proportional to the frequency of occurrences of the specified element in the plurality of data. Besides, the similarity is calculated on the basis of the generated specified element vector and the specified element vector of the specified element vector storage device by the similarity calculation component.

Here, the specified element vector generation component may have any structure as long as it is adapted to generate the specified element vector on the basis of the data-for-decision. By way of example, the generation component may directly generate the specified element vector from the data-for-decision, or it may well generate an intermediate product (for example, another vector) from the data-for-decision and then generate the specified element vector from the generated intermediate product. The same holds true of a similarity calculation program, and a similarity calculation method, described below.

Besides, the specified element vector storage component can store the specified element vector by any means and at any time. It may store the specified element vector beforehand, or it may well store the specified element vector by an external input or the like during the operation of this device without storing them beforehand. The same holds true of a similarity calculation device, a similarity calculation program, and a similarity calculation method, described below.

Further, a similarity calculation device can include a device wherein a similarity to a specified character string is calculated on the basis of a character string vector indicating a feature of the specified character string. The device can include a character string vector storage component that stores the character string vector, data-for-decision input device for inputting data-for-decision containing a specified character string for similarity decision, character string vector generation component for generating said character string vector on the basis of the data-for-decision inputted by said data-for-decision input component, and similarity calculation device for calculating said similarity on the basis of the character string vector generated by said character string vector generation device and the character string vector of said character string vector storage component. The character string vector can have elements corresponding to the respective plurality of document data, and each of said elements can have a value which is proportional to a frequency of occurrences of said specified character string in the corresponding one of said plurality of document data and which is inversely proportional to a frequency of occurrences of said specified character string in said plurality of document data.

With such structure, when the data-for-decision is inputted from the data-for-decision input component, the character string vector is generated on the basis of the inputted data-for-decision by the character string vector generation component. The character string vector has the elements corresponding to the respective document data, and each of the elements is generated so as to become the value which is proportional to the frequency of occurrences of the specified character string in the corresponding one of the plurality of document data and which is inversely proportional to the frequency of occurrences of the specified character string in the plurality of document data. Besides, the similarity is calculated on the basis of the generated character string vector and the character string vector of the character string vector storage component by the similarity calculation component.

Here, the character string vector generation component may have any structure as long as it is adapted to generate the character string vector on the basis of the data-for-decision. By way of example, the generation component may directly generate the character string vector from the data-for-decision, or it may well generate an intermediate product (for example, another vector) from the data for decision and then generate the character string vector from the generated intermediate product. The same holds true of a similarity calculation program, and a similarity calculation method, described below.

Further, in the similarity calculation device of the invention, the specified character string can be either of a morpheme obtained by a morpheme analysis and a character string extracted in accordance with a predetermined rule. With such structure, when the data-for-decision is inputted from the data-for-decision input component, the character string vector is generated on the basis of the inputted data-for-decision by the character string vector generation component. The character string vector has the elements corresponding to the respective document data, and each of the elements is generated so as to become the value which is proportional to the frequency of occurrences of the specified morpheme or the extracted character string in the corresponding one of the plurality of document data and which is inversely proportional to the frequency of occurrences of the specified morpheme or the extracted character string in the plurality of document data. Besides, the similarity is calculated on the basis of the generated character string vector and the character string vector of the character string vector storage device by the similarity calculation device.

Further, the similarity calculation device of the invention can include that the character string vector generation component reads out a character string vector concerning the same character string as the specified character string contained in said data-for-decision, from said character string vector storage component.

With such structure, the character string vector concerning the same character string as the specified character string contained in the data-for-decision is read out from the character string vector storage component by the character string vector generation component. Thus, the character string vector is generated.

Further, the similarity calculation device of the invention can further include that, when a plurality of the character string vectors concerning the same character string as the specified character string contained in said data-for-decision exist in said character string vector storage component, the character string vector generation device reads out the character string vectors from said character string vector storage component and then generates the single character string vector on the basis of said character string vectors read out.

With such structure, when a plurality of such character string vectors concerning the same character string as the specified character string contained in the data-for-decision exist in the character string vector storage component, the character string vectors are read out from the character string vector storage component so as to generate the single character string vector on the basis of the read-out character string vectors, by the character string vector generation component.

Further, the similarity calculation device of the present invention can include that said character string vector generation component reads out the character string vector concerning the same character string as the specified character string contained in said data-for-decision, from said character string vector storage component, calculates average values of elements of the same dimensions as to the character string vectors read out, and generates the character string vector which has the calculated average values as values of its elements, respectively.

With such structure, owing to the character string vector generation component, the character string vectors concerning the same character string as the specified character string contained in the data-for-decision are read out from the character string vector storage component, the average values of the elements of the same dimensions are calculated as to the read-out character string vectors, and the character string vector which has the calculated average values as the values of its elements, respectively, is generated.

Further, the similarity calculation device of the present invention can include that the character string vector storage component stores said character string vector in association with a classification attribute of a pertinent word, that the data-for-decision input component inputs said data-for-decision and the classification attribute, that the character string vector generation device reads out the character string vector concerning the same character string as the specified character string contained in said data-for-decision, from said character string vector storage component, and that said similarity calculation component reads out the character string vector corresponding to the classification attribute inputted by said data-for-decision input component, from the character string vector storage component, and then calculates the similarity on the basis of the read-out character string vector and the character string vector generated by the character string vector generation component.

With such structure, when the data-for-decision and the classification attribute are inputted, the character string vector concerning the same character string as the specified character string contained in the data-for-decision is read out from the character string vector storage component and is generated as the character string vector, by the character string vector generation component. Besides, owing to the similarity calculation component, the character string vector corresponding to the inputted classification attribute is read out from the character string vector storage component, and the similarity is calculated on the basis of the read-out character string vector and the generated character string vector.

Here, the classification attribute shall cover not only a part of speech, but also several fields such as a title, the text, and an author, in case of a news story tagged by a tag language, for example, the XML (eXtensible Markup Language). The same can hold true of a similarity calculation device, described below.

Further, the similarity calculation device of the invention can include that the classification attribute is a part of speech.

With such structure, when the data-for-decision and the part of speech are inputted, the character string vector concerning the same character string as the specified character string contained in the data-for-decision is read out from the character string vector storage component and is generated as the character string vector, by the character string vector generation component. Besides, owing to the similarity calculation device, the character string vector corresponding to the inputted part of speech is read out from the character string vector storage component, and the similarity is calculated on the basis of the read-out character string vector and the generated character string vector.

Further, a similarity calculation device in a device wherein a specified element vector indicating a feature of a specified element is generated on the basis of a plurality of data, and a similarity to said specified element is calculated on the basis of said specified element vector, can include a first specified element vector generation component that generates the specified element vector on the basis of said plurality of data. The component can further include a specified element vector storage component that stores the specified element vector generated by the first specified element vector generation component, data-for-decision input device for inputting data-for-decision containing a specified element for similarity decision, second specified element vector generation component for generating said specified element vector on the basis of the data-for-decision inputted by said data-for-decision input component, and similarity calculation component calculating said similarity on the basis of the specified element vector generated by said second specified element vector generation component and the specified element vector of said specified element vector storage device. The specified element vector can have elements corresponding to the respective data, and each of the elements can have a value which is proportional to a frequency of occurrences of the specified element in the corresponding one of said plurality of data and which is inversely proportional to a frequency of occurrences of said specified element in said plurality of data.

With such structure, the specified request vector can be generated on the basis of the plurality of data by the first specified request vector generation component, and the generated specified element vector is stored in the specified element vector storage component. The specified request vector has the elements corresponding to the respective data, and each of the elements is generated so as to become the value which is proportional to the frequency of occurrences of the specified element in the corresponding one of the plurality of data and which is inversely proportional to the frequency of occurrences of the specified element in the plurality of data.

Besides, when the data-for-decision is inputted from the data-for-decision input device, the specified element vector is generated on the basis of the inputted data-for-decision by the second specified element vector generation device. The specified element vector has the elements corresponding to the respective data, and each of the elements is generated so as to become the value which is proportional to the frequency of occurrences of the specified element in the corresponding one of the plurality of data and which is inversely proportional to the frequency of occurrences of the specified element in the plurality of data. Besides, the similarity is calculated on the basis of the generated specified element vector and the specified element vector of the specified element vector storage device by the similarity calculation device.

Here, the first specified element vector generation device may have any structure as long as it is adapted to generate the specified element vector on the basis of the plurality of data. By way of example, the generation device may directly generate the specified element vector from the plurality of data, or it may well generate an intermediate product (for example, another vector) from the plurality of data and then generate the specified element vector from the generated intermediate product. The same can hold true of a similarity calculation program, and a similarity calculation method, described below.

Besides, the second specified element vector generation device may have any structure as long as it is adapted to generate the specified element vector on the basis of the data-for-decision. By way of example, the generation device may directly generate the specified element vector from the data-for-decision, or it may well generate an intermediate product (for example, another vector) from the data-for-decision and then generate the specified element vector from the generated intermediate product. The same holds true of the similarity calculation program, and the similarity calculation method, as described below.

Further, a similarity calculation device wherein a character string vector indicating a feature of a specified character string is generated on the basis of a plurality of document data, and a similarity to said specified character string is calculated on the basis of said character string vector, can include a first character string vector generation component that generates the said character string vector on the basis of said plurality of document data, character string vector storage component for storing the character string vector generated by said first character string vector generation component, data-for-decision input component for inputting data-for-decision containing a specified character string for similarity decision, second character string vector generation component for generating said character string vector on the basis of the data-for-decision inputted by said data-for-decision input component, and similarity calculation component for calculating said similarity on the basis of the character string vector generated by said second character string vector generation component and the character string vector of said character string vector storage component. The character string vector can have elements corresponding to the respective document data, and each of said elements has a value which is proportional to a frequency of occurrences of said specified character string in the corresponding one of said plurality of document data and which is inversely proportional to a frequency of occurrences of the specified character string in the plurality of document data.

With such structure, the character string vector can be generated on the basis of the plurality of document data by the first character string vector generation component, and the generated character string vector is stored in the character string vector storage component. The character string vector has the elements corresponding to the respective document data, and each of the elements is generated so as to become the value which is proportional to the frequency of occurrences of the specified character string in the corresponding one of the plurality of document data and which is inversely proportional to the frequency of occurrences of the specified character string in the plurality of document data.

Besides, when the data-for-decision is inputted from the data-for-decision input device, the character string vector is generated on the basis of the inputted data-for-decision by the second character string vector generation component. The character string vector has the elements corresponding to the respective document data, and each of the elements is generated so as to become the value which is proportional to the frequency of occurrences of the specified character string in the corresponding one of the plurality of document data and which is inversely proportional to the frequency of occurrences of the specified character string in the plurality of document data. Besides, the similarity is calculated on the basis of the generated character string vector and the character string vector of the character string vector storage device by the similarity calculation component.

Here, the first character string vector generation component may have any structure as long as it is adapted to generate the character string vector on the basis of the plurality of document data. By way of example, the generation component may directly generate the character string vector from the plurality of document data, or it may well generate an intermediate product (for example, another vector) from the plurality of document data and then generate the character string vector from the generated intermediate product. The same holds true of a similarity calculation program, and a similarity calculation method, described below.

Besides, the second character string vector generation component may have any structure as long as it is adapted to generate the character string vector on the basis of the data-for-decision. By way of example, the generation component may directly generate the character string vector from the data-for-decision, or it may well generate an intermediate product (for example, another vector) from the data-for-decision and then generate the character string vector from the generated intermediate product. The same holds true of the similarity calculation program, and the similarity calculation method, described below.

Further, in the similarity calculation device of the present invention can include that the specified character string is either of a morpheme obtained by a morpheme analysis and a character string extracted in accordance with a predetermined rule.

With such structure, the character string vector is generated on the basis of the plurality of document data by the first character string vector generation component, and the generated character string vector is stored in the character string vector storage component. The character string vector has the elements corresponding to the respective document data, and each of the elements is generated so as to become the value which is proportional to the frequency of occurrences of the specified morpheme or the extracted character string in the corresponding one of the plurality of document data and which is inversely proportional to the frequency of occurrences of the specified morpheme or the extracted character string in the plurality of document data.

Besides, when the data-for-decision is inputted from the data-for-decision input device, the character string vector is generated on the basis of the inputted data-for-decision by the second character string vector generation component. The character string vector has the elements corresponding to the respective document data, and each of the elements is generated so as to become the value which is proportional to the frequency of occurrences of the specified morpheme or the extracted character string in the corresponding one of the plurality of document data and which is inversely proportional to the frequency of occurrences of the specified morpheme or the extracted character string in the plurality of document data. Besides, the similarity is calculated on the basis of the generated character string vector and the character string vector of the character string vector storage device by the similarity calculation component.

Further, the similarity calculation device of the invention can have include that the second character string vector generation device reads out a character string vector concerning the same character string as the specified character string contained in said data-for-decision, from said character string vector storage component.

With such structure, the character string vector concerning the same character string as the specified character string contained in the data-for-decision can be read out from the character string vector storage component by the second character string vector generation component. Thus, the character string vector is generated.

Further, in the similarity calculation device can include that, when a plurality of the character string vectors concerning the same character string as the specified character string contained in said data-for-decision exist in said character string vector storage component, the second character string vector generation component reads out the character string vectors from the character string vector storage component, and then generates the single character string vector on the basis of the character string vectors read out.

With such structure, when a plurality of such character string vectors concerning the same character string as the specified character string contained in the data-for-decision exist in the character string vector storage component, the character string vectors are read out from the character string vector storage component so as to generate the single character string vector on the basis of the read-out character string vectors, by the second character string vector generation component.

Further, the similarity calculation device of the present invention can include that the second character string vector generation component reads out the character string vectors concerning the same character string as the specified character string contained in the data-for-decision, from the character string vector storage component, calculates average values of elements of the same dimensions as to the character string vectors read out, and generates the character string vector which has the calculated average values as values of its elements, respectively.

With such structure, owing to the second character string vector generation component, the character string vectors concerning the same character string as the specified character string contained in the data-for-decision are read out from the character string vector storage component, the average values of the elements of the same dimensions are calculated as to the read-out character string vectors, and the character string vector which has the calculated average values as the values of its elements, respectively, is generated.

Further, the similarity calculation device of the present invention can include that the character string vector storage component stores said character string vector in association with a classification attribute of a pertinent word, that the data-for-decision input device inputs said data-for-decision and the classification attribute, that said second character string vector generation component reads out the character string vector concerning the same character string as the specified character string contained in said data-for-decision, from said character string vector storage component, and that the similarity calculation device reads out the character string vector corresponding to the classification attribute inputted by the data-for-decision input device, from said character string vector storage component, and then calculates said similarity on the basis of the read-out character string vector and the character string vector generated by said character string vector generation component.

With such structure, when the data-for-decision and the classification attribute are inputted, the character string vector concerning the same character string as the specified character string contained in the data-for-decision is read out from the character string vector storage component and is generated as the character string vector, by the second character string vector generation component. Besides, owing to the similarity calculation device, the character string vector corresponding to the inputted classification attribute is read out from the character string vector storage component, and the similarity is calculated on the basis of the read-out character string vector and the generated character string vector.

Further, the similarity calculation device can include that the classification attribute is a part of speech.

With such structure, when the data-for-decision and the part of speech are inputted, the character string vector concerning the same character string as the specified character string contained in the data-for-decision is read out from the character string vector storage component and is generated as the character string vector, by the second character string vector generation component. Besides, owing to the similarity calculation device, the character string vector corresponding to the inputted part of speech is read out from the character string vector storage component, and the similarity is calculated on the basis of the read-out character string vector and the generated character string vector.

Meanwhile, in order to accomplish the above object, a specified element vector generation program can include a program wherein a specified element vector indicating a feature of a specified element is generated on the basis of a plurality of data can further include being a program for causing a computer to execute a process which is implemented as specified element vector generation device for generating said specified element vector on the basis of said plurality of data. Wherein the specified element vector can have elements corresponding to said respective data, and each of the elements can have a value which is proportional to a frequency of occurrences of said specified element in the corresponding one of said plurality of data and which is inversely proportional to a frequency of occurrences of said specified element in said plurality of data.

With such structure, when the program is read by the computer, which then executes the process in accordance with the read program, an operation equivalent to the specified element vector generation device of the invention is attained.

Meanwhile, in order to accomplish the above object, a character string vector generation program can include a program wherein a character string vector indicating a feature of a specified character string is generated on the basis of a plurality of document data and can further include being a program for causing a computer to execute a process which is implemented as character string vector generation component for generating said character string vector on the basis of said plurality of document data. Wherein said character string vector has elements corresponding to the respective document data, and each of said elements has a value which is proportional to a frequency of occurrences of the specified character string in the corresponding one of the plurality of document data and which is inversely proportional to a frequency of occurrences of the specified character string in the plurality of document data.

With such structure, when the program is read by the computer, which then executes the process in accordance with the read program, an operation equivalent to the specified element vector generation device of the above invention is attained.

Meanwhile, in order to accomplish the above object, a similarity calculation program can include a program wherein a similarity to a specified element is calculated on the basis of a specified element vector indicating a feature of the specified element, and can further include a program for causing a computer, which can utilize specified element vector storage component for storing the specified element vector, and a data-for-decision input device for inputting data-for-decision containing a specified element for similarity decision, to execute a process which is implemented as specified element vector generation component for generating the specified element vector on the basis of the data-for-decision inputted by said data-for-decision input component, and similarity calculation component for calculating said similarity on the basis of the specified element vector generated by the specified element vector generation component and the specified element vector of said specified element vector storage component. The specified element vector having elements corresponding to the respective data, and each of the elements having a value which is proportional to a frequency of occurrences of the specified element in the corresponding one of the plurality of data and which is inversely proportional to a frequency of occurrences of the specified element in said plurality of data.

With such structure, when the program is read by the computer, which then executes the process in accordance with the read program, an operation equivalent to the similarity calculation device of the above invention can be attained.

Further, a similarity calculation program in a program wherein a similarity to a specified character string is calculated on the basis of a character string vector indicating a feature of the specified character string, can include being a program for causing a computer, which can utilize character string vector storage component for storing said character string vector, and data-for-decision input device for inputting data-for-decision containing a specified character string for similarity decision, to execute a process which is implemented as character string vector generation component for generating the character string vector on the basis of the data-for-decision inputted by the data-for-decision input component, and similarity calculation component for calculating the similarity on the basis of the character string vector generated by the character string vector generation component and the character string vector of the character string vector storage component. The character string vector has elements corresponding to the respective document data, and each of the elements has a value which is proportional to a frequency of occurrences of the specified character string in the corresponding one of the plurality of document data and which is inversely proportional to a frequency of occurrences of the specified character string in the plurality of document data.

With such structure, when the program is read by the computer, which then executes the process in accordance with the read program, an operation equivalent to the similarity calculation component, described above, can be attained.

Further, a similarity calculation program in a program wherein a specified element vector indicating a feature of a specified element is generated on the basis of a plurality of data, and a similarity to said specified element is calculated on the basis of said specified element vector, can further include being a program for causing a computer, which can utilize specified element vector storage component for storing the specified element vector, and data-for-decision input device for inputting data-for-decision containing a specified element for similarity decision, to execute a process which is implemented as first specified element vector generation component for generating the specified element vector on the basis of the plurality of data and then storing the generated vector in the specified element vector storage component, second specified element vector generation device for generating the specified element vector on the basis of the data-for-decision inputted by the data-for-decision input component, and similarity calculation component for calculating said similarity on the basis of the specified element vector generated by the second specified element vector generation component and the specified element vector of the specified element vector storage component. The specified element vector can have elements corresponding to said respective data, and each of said elements can have a value which is proportional to a frequency of occurrences of the specified element in the corresponding one of said plurality of data and which is inversely proportional to a frequency of occurrences of said specified element in the plurality of data.

With such structure, when the program is read by the computer, which then executes the process in accordance with the read program, an operation equivalent to the specified element vector generation program the above invention can be attained.

Further, a similarity calculation program in a program wherein a character string vector indicating a feature of a specified character string is generated on the basis of a plurality of document data, and a similarity to said specified character string is calculated on the basis of the character string vector, characterized by being a program for causing a computer, which can utilize character string vector storage component for storing the character string vector, and data-for-decision input component for inputting data-for-decision containing a specified character string for similarity decision, to execute a process which is implemented as first character string vector generation component for generating said character string vector on the basis of the plurality of document data and then storing the generated vector in the character string vector storage device, second character string vector generation component for generating the character string vector on the basis of the data-for-decision inputted by the data-for-decision input component, and similarity calculation component for calculating the similarity on the basis of the character string vector generated by the second character string vector generation component and the character string vector of the character string vector storage component. The character string vector having elements corresponding to said respective document data, and each of said elements having a value which is proportional to a frequency of occurrences of said specified character string in the corresponding one of the plurality of document data and which is inversely proportional to a frequency of occurrences of the character string in the plurality of document data.

With such structure, when the program is read by the computer, which then executes the process in accordance with the read program, an operation equivalent to the character string vector generation program of the above invention can be attained.

Meanwhile, in order to accomplish the above object, a specified element vector generation method in a method wherein a specified element vector indicating a feature of a specified element is generated on the basis of a plurality of data, can include a specified element vector generation step of generating said specified element vector on the basis of said plurality of data. The specified element vector can have elements corresponding to said respective data, and each of said elements can have a value which is proportional to a frequency of occurrences of said specified element in the corresponding one of said plurality of data and which is inversely proportional to a frequency of occurrences of said specified element in said plurality of data.

Meanwhile, in order to accomplish the above object, a character string vector generation method in a method wherein a specified element vector indicating a feature of a specified element is generated on the basis of a plurality of document data, can include a character string vector generation step of generating said character string vector on the basis of said plurality of document data. The character string vector can have elements corresponding to said respective document data, and each of said elements can have a value which is proportional to a frequency of occurrences of said specified character string in the corresponding one of said plurality of document data and which is inversely proportional to a frequency of occurrences of said specified character string in said plurality of document data.

Meanwhile, in order to accomplish the above object, a similarity calculation method in a method wherein a similarity to a specified element is calculated on the basis of a specified element vector indicating a feature of the specified element, can include a specified element vector storage step of storing said specified element vector in a specified element vector storage component, a data-for-decision input step of inputting data-for-decision containing a specified element for similarity decision, a specified element vector generation step of generating said specified element vector on the basis of the data-for-decision inputted at the data-for-decision input step, and a similarity calculation step of calculating said similarity on the basis of the specified element vector generated at said specified element vector generation step and the specified element vector of said specified element vector storage component. The specified element vector can have elements corresponding to the respective data, and each of the elements can have a value which is proportional to a frequency of occurrences of the specified element in the corresponding one of the plurality of data and which is inversely proportional to a frequency of occurrences of the specified element in the plurality of data.

Further, a similarity calculation method in a method wherein a similarity to a specified character string is calculated on the basis of a specified character vector indicating a feature of the specified character string, can include a character string vector storage step of storing said character string vector in the character string vector storage component, a data-for-decision input step of inputting data-for-decision containing a specified character string for similarity decision, a character string vector generation step of generating the character string vector on the basis of the data-for-decision inputted at the data-for-decision input step, and a similarity calculation step of calculating the similarity on the basis of the character string vector generated at the character string vector generation step and the character string vector of said character string vector storage component. The character string vector can have elements corresponding to the respective document data, and each of the elements can have a value which is proportional to a frequency of occurrences of the specified character string in the corresponding one of said plurality of document data and which is inversely proportional to a frequency of occurrences of said specified character string in said plurality of document data.

Further, a similarity calculation method in a method wherein a specified element vector indicating a feature of a specified element is generated on the basis of a plurality of data, and a similarity to said specified element is calculated on the basis of the specified element vector, can include a first specified element vector generation step of generating the specified element vector on the basis of the plurality of data, a specified element vector storage step of storing the specified element vector generated at the first specified element vector generation step, in specified element storage means, a data-for-decision input step of inputting data-for-decision containing a specified element for similarity decision, a second specified element vector generation step of generating the specified element vector on the basis of the data-for-decision inputted at the data-for-decision input step, and a similarity calculation step of calculating the similarity on the basis of the specified element vector generated at the second specified element vector generation step and the specified element vector of the specified element vector storage component. The specified element vector can have elements corresponding to said respective data, and each of said elements can have a value which is proportional to a frequency of occurrences of said specified element in the corresponding one of said plurality of data and which is inversely proportional to a frequency of occurrences of said specified element in said plurality of data.

Further, a similarity calculation method in a method wherein a character string vector indicating a feature of a specified character string is generated on the basis of a plurality of document data, and a similarity to said specified character string is calculated on the basis of said character string vector, can include a first character string vector generation step of generating said character string vector on the basis of said plurality of document data, a character string vector storage step of storing the character string vector generated at the first character string vector generation step, in character string vector storage device, a data-for-decision input step of inputting data-for-decision containing a specified character string for similarity decision, a second character string vector generation step of generating the character string vector on the basis of the data-for-decision inputted at the data-for-decision input step, and a similarity calculation step of calculating the similarity on the basis of the character string vector generated at the second character string vector generation step and the character string vector of the character string vector storage device. The character string vector can have elements corresponding to said respective document data, and each of said elements can have a value which is proportional to a frequency of occurrences of said specified character string in the corresponding one of the plurality of document data and which is inversely proportional to a frequency of occurrences of the specified character string in said plurality of document data.

### BRIEF DESCRIPTION OF THE DRAWINGS

The invention will be described with reference to the accompanying drawings, wherein like numerals reference like elements, and wherein:

FIG. 1 is an exemplary block diagram showing the structure of a computer 100 for applying the present invention;

FIG. 2 is a flow chart showing an exemplary word vector generation process;

FIG. 3 is a diagram showing the composition of a document vector;

FIG. 4 is a flow chart showing an exemplary similarity calculation process;

FIG. 5 shows a sample of document data;

FIG. 6 shows the list of words whose similarities to a retrieval keyword “fingerprint” are high;

FIG. 7 shows the list of English words whose similarities to the retrieval keyword “fingerprint” are high; and

FIG. 8 shows the list of words whose similarities to the retrieval keyword “fingerprint” are high.

### DETAILED DESCRIPTION OF PREFERRED EMBODIMENTS

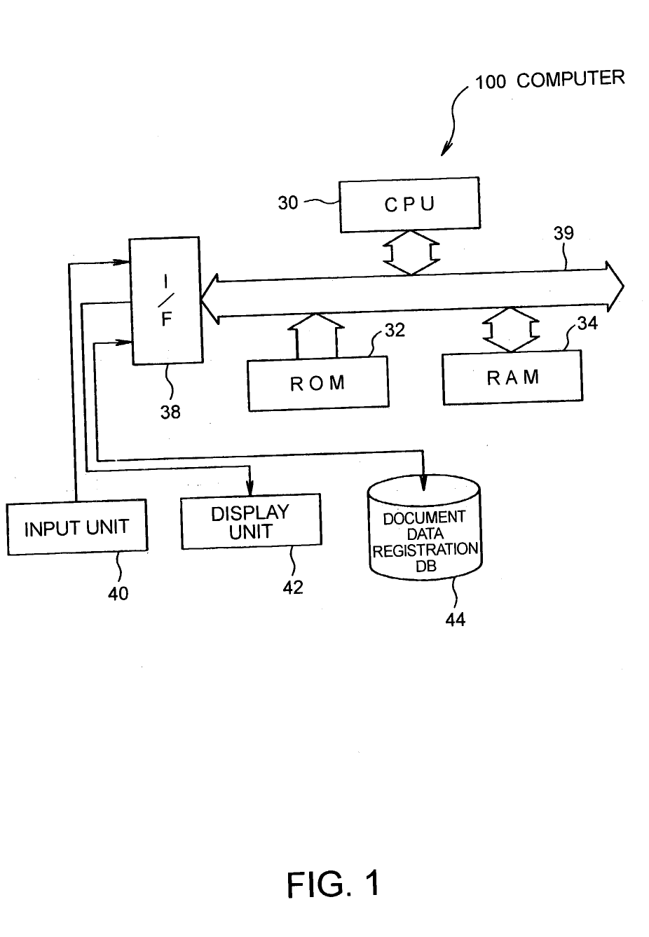

Now, embodiments of the present invention will be described with reference to the drawings. FIG. 1 through FIG. 8 are diagrams showing an embodiment of a specified element vector generation device, a character string vector generation device, a similarity calculation device, a specified element vector generation program, a character string vector generation program, a similarity calculation program, a specified element vector generation method, a character string vector generation method, and a similarity calculation method according to the present invention.

This embodiment is such that the specified element vector generation device, character string vector generation device, similarity calculation device, specified element vector generation program, character string vector generation program, similarity calculation program, specified element vector generation method, character string vector generation method, and similarity calculation method according to the present invention are applied to a case where, for a retrieval keyword inputted by a user, similarities to all kinds of words contained in a plurality of document data are respectively calculated by a computer 100 as shown in FIG. 1.

First, the structure of the computer 100 for applying the present invention will be described with reference to FIG. 1. FIG. 1 is an exemplary block diagram showing the structure of the computer 100 for applying the present invention.

As shown in FIG. 1, the computer 100 is constructed of a CPU 30 which controls operations and the whole system on the basis of a control program, a ROM 32 which stores the control program of the CPU 30, etc. in predetermined areas beforehand, a RAM 34 which serves to store data read out from the ROM 32, etc. and operated results necessary in the operating process of the CPU 30, and an I/F 38 through which data are inputted from and outputted to external devices, these constituents being connected to one another so as to be capable of exchanging data, by a bus 39 which consists of signal lines for transferring data.

Connected as the external devices to the I/F 38 are an input unit 40 which can include a keyboard, a mouse, etc. capable of inputting data as human interfaces, a display unit 42 which displays a screen on the basis of an image signal, and a document data registration database (hereinbelow, the database shall be simply abbreviated to “DB”) 44 in which a plurality of document data are stored.

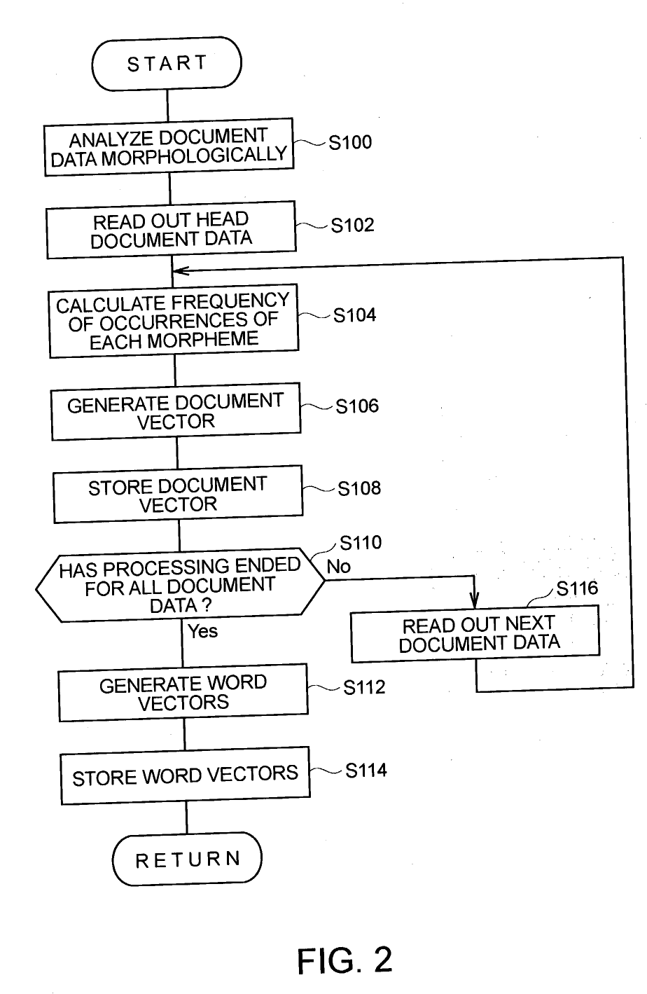

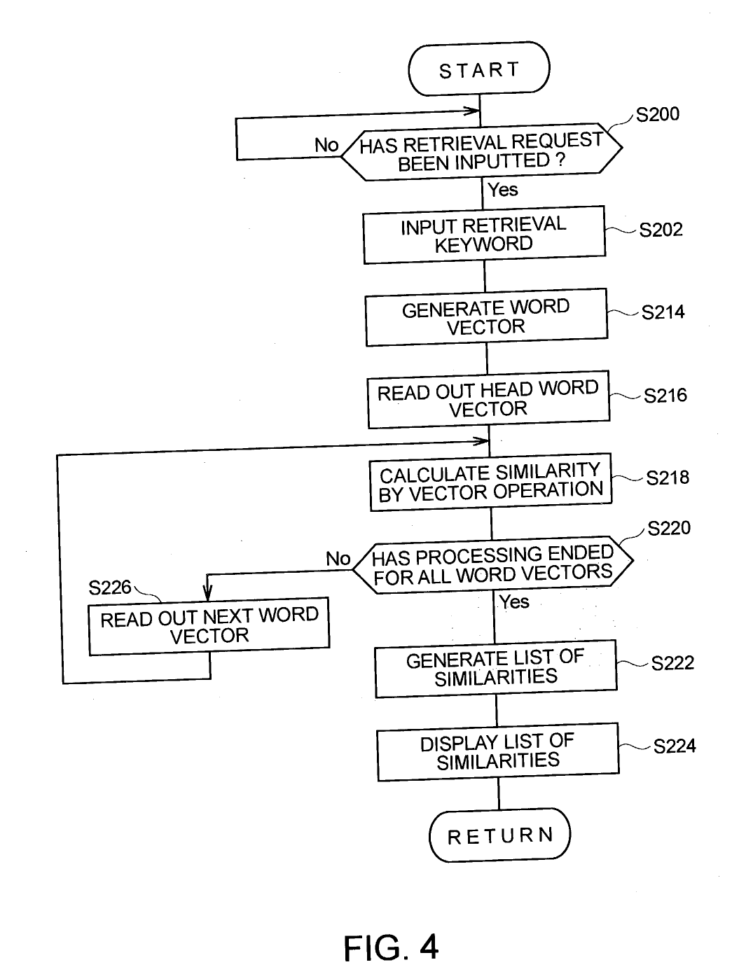

The CPU 30 is made of a micro processing unit, MPU or the like, and it starts predetermined programs stored in the predetermined areas of the ROM 32, whereby a word vector generation process and a similarity calculation process shown in the flow charts of FIG. 2 and FIG. 4 are respectively executed in time division in accordance with the programs.

Initially, the word vector generation process will be described in detail with reference to FIG. 2. FIG. 2 is the flow chart showing the word vector generation process.

The word vector generation process is a process for generating a word vector necessary for the calculation of a similarity, and when executed by the CPU 30, it first shifts to a step S100 as shown in FIG. 2.

At the step S100, all the document data of the document data registration DB 44 are analyzed by a morpheme analysis, and all kinds of morphemes which occur in any of the document data are acquired. Thereafter, the routine shifts to a step S102 at which the head document data is read out from the document data registration DB 44, and it shifts to a step S104.

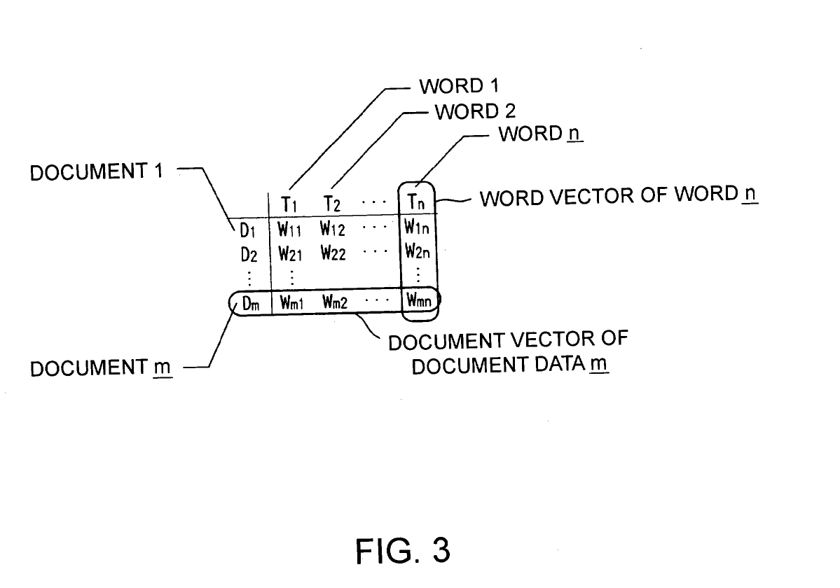

At the step S104, the frequency of occurrences of each of the morphemes acquired at the step S100 is calculated in the document data read out. Thereafter, the routine shifts to a step S106 at which a document vector is generated on the basis of such frequencies of occurrences calculated. The document vector has elements corresponding to the respective morphemes, and it is generated so that each element may become a value conforming to the frequency of occurrences of the corresponding morpheme. Here, a method of generating the document vector will be described with reference to FIG. 3. FIG. 3 is an exemplary diagram showing the composition of the document vector.

First, as shown in FIG. 3, the document vector can be represented as an n-dimensional vector by an equation (1) given below. In general, n denotes the number of non-repeated words (the number of morphemes) which are obtained when all the document data have been analyzed by a morpheme analysis. Besides, the weight W of each word is obtained by TFIDF (Term Frequency & Inverse Document Frequency).

D=(W₁,W₂, . . . , Wₙ) (1)

The TFIDF is obtained as the product between the frequency of occurrences of the word in single document data (TF: Term Frequency) and the inverse number of the number of the document data in which the word is used in all document data (IDF: Inverse Document Frequency), by an equation (2) given below, and a larger numerical value thereof indicates that the word is more important. The TF is an index which indicates that the word occurring frequently is important, and it has the character of becoming larger with increase in the frequency at which the word occurs in certain document data, as indicated by an equation (3) given below. The IDF is an index which indicates that the word occurring in a large number of document data is not important, namely, that the word occurring in the specified document data is important, and it has the character of becoming larger with decrease in the number of document data in which the certain word is used, as indicated by equations (4)-(6) given below. Accordingly, the value of the TFIDF has the character of becoming small for any word (a conjunction, a postpositional word functioning as an auxiliary to a main word, or the like) which occurs frequently, but which occurs in the large number of document data, or any word which occurs in only the specified document data, but whose frequency is low even in this document data, and conversely becoming large for any word which occurs at a high frequency in the specified document data. The words in the document data are turned into numerical values by the TFIDF, and the document data can be vectorized using the numerical values as elements.

W(t,d)=TF(t,d)xIDF(t) (2)

TF(t,d)=Frequency of occurrence of the word t in the document data (3)

$$IDF ( t ) = log ( \frac{D}{DF ( t )} ) \qquad ( 4 )$$

DF(t)=The number of the document data in which the word t occurs in all the document data (5)

D=The number of all the document data (6)

Subsequently, the routine shifts to a step S108, at which the generated document vector is stored in the document data registration DB 44, and it shifts to a step S110, which decides whether or not the processing of the steps S104-S108 has ended for all the document data. Subject to the decision (Yes) that the processing has ended for all the document data, the routine shifts to a step S112.

At the step S112, word vectors are generated on the basis of the document vectors of the document data registration DB 44. Each of the word vectors has elements corresponding to the respective document data, and it is generated so that each of the elements may become a value which conforms to the frequency of occurrences of the pertinent word in the corresponding document data. Concretely, as shown in FIG. 3, a document word matrix in which document vector components are taken in a row direction is formed by gathering all the generated document vectors, components in the column direction of the document word matrix are extracted from this document word matrix, and the vector of the extracted components is generated as the word vector.

Subsequently, the routine shifts to a step S114 at which the generated word vectors are stored in the document data registration DB 44, whereupon the series of processing steps are ended to return to the original process.

On the other hand, when it is decided (No) at the step S110 that the processing of the steps S104-S108 has not ended for all the document data, the routine shifts to a step S116, at which the next document data is read out from the document data registration DB 44, followed by the step S104.

Next, a similarity calculation process will be described in detail with reference to FIG 4. FIG. 4 is a flow chart showing the similarity calculation process.

The similarity calculation process is a process in which similarities to all kinds of words contained in a plurality of document data are respectively calculated for a retrieval keyword inputted by a user, on the basis of the word vectors of the document data registration DB 44. When executed by the CPU 30, the similarity calculation process first shifts to a step 200 as shown in FIG. 4.

At the step S200, whether or not a retrieval request by a user has been inputted is decided. Subject to the decision (Yes) that the retrieval request has been inputted, the routine shifts to a step S202, but subject to the other decision (No), the routine stands by at the step S200 until the retrieval request is inputted.

At the step S202, a retrieval keyword is inputted from the input unit 40, and the routine shifts to a step S214, at which the word vector of the retrieval keyword (hereinbelow, the word vector of the retrieval keyword shall be called the “retrieval key word vector ”) is generated on the basis of the inputted retrieval keyword. Concretely, at the step S214, the word vector concerning the same word as the retrieval keyword, among the word vectors generated at the step S112, is read out from the document data registration DB 44. Here, when a plurality of word vectors concerning the same word as the retrieval keyword are existent in the document data registration DB 44, the word vectors are read out from the document data registration DB 44, the average values of elements of the same dimensions are calculated as to the word vectors read out, and a word vector which has the calculated average values as the values of the respective elements is generated.

Subsequently, the routine shifts to a step S216 at which the head one of the word vectors generated at the step S112 is read out from the document data registration DB 44, and it shifts to a step S218 at which a vector operation is executed using the read-out word vector and the retrieval key word vector, thereby to calculate the similarity between the words corresponding to these word vectors. The calculation of the similarity based on the vector operation is called the “vector retrieval technique”, and this technique consists of the TFIDF which turns words into numerical values while reflecting the degrees of importance thereof, and a vector space model which computes the similarity of words vectorized with the numerical values. By way of example, letting the read-out word vector be a word vector Ti, and the retrieval key word vector be a word vector T2, the similarity can be calculated as the cosine value (0-1) of an angle defined between the word vectors T1 and T2, by an equation (7) given below.

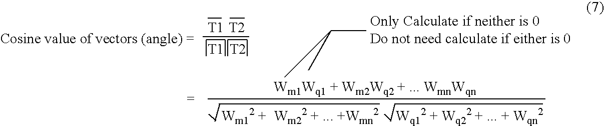

Subsequently, the routine shifts to a step S220, which decides whether or not the processing of the step S218 has ended for all word vectors. Subject to the decision (Yes) that the processing has ended for all the word vectors, the routine shifts to a step S222.

At the step S222, the list of similarities is generated by rearranging the similarities calculated at the step S218, in the sequence of higher similarities. Thereafter, the routine shifts to a step S224, at which the generated list of the similarities is displayed on the display unit 42. The series of processing steps are ended to return to the original process.

Meanwhile, when it is decided (No) at the step S220 that the processing of the step S218 has not ended for all the word vectors, the routine shifts to a step S226, at which the next one of the word vectors generated at the step S112 is read out from the document data registration DB 44, followed by the step S218.

Next, the operation of this embodiment will be described.

Initially, there will be described a case where word vectors are generated from the document data of the document data registration DB 44.

First, via the steps S100 and S102, all the document data of the document data registration DB 44 are analyzed by a morpheme analysis, all kinds of morphemes occurring in any document data are acquired, and the head document data is read out from the document data registration DB 44. Subsequently, via the steps S104 and S106, the frequency of occurrences of the morpheme in the read-out document data is calculated for each of acquired morpheme, and a document vector is generated on the basis of the calculated frequencies of occurrences. The document vector has elements corresponding to the respective morphemes, and it is generated so that the respective elements may become values conforming to the frequencies of occurrences of the corresponding morphemes. Thereafter, the document vector is stored in the document data registration DB 44 via the step S108. The generation of such document vectors proceeds for all the document data of the document data registration DB 44 by repeating the steps S104-S110 and S116.

Upon the generation of the document vectors for all the document data, via the step S112, word vectors are generated on the basis of the document vectors of the document data registration DB 44. Each of the word vectors has elements corresponding to the respective document data, and it is generated so that the respective elements may become values conforming to the frequencies of occurrences of the pertinent word in the corresponding document data. Concretely, a document word matrix in which document vector components are taken in a row direction is formed by gathering all the generated document vectors, components in the column direction of the document word matrix are extracted from this document word matrix, and the vector of the extracted components is generated as the word vector. Thereafter, the word vectors are stored in the document data registration DB 44 via the step S114.

Next, there will be described a case where the similarities of a retrieval keyword inputted by a user are calculated.

In the case of calculating the similarities of the retrieval keyword, the user first inputs a retrieval request and also inputs the retrieval keyword whose similarities are to be decided.

Upon the input of the retrieval keyword, via the steps S214 and S216, a retrieval key word vector is generated on the basis of the inputted retrieval keyword, and the head one of the word vectors generated at the step S112 is read out from the document data registration DB 44. Subsequently, using the read-out word vector and the retrieval key word vector, a vector operation is executed via the step S218, whereby the similarity between these word vectors is calculated. The calculation of such similarities proceeds for all the word vectors generated at the step S112, by repeating the steps S218, S220 and S226.

Upon the calculation of the similarities for all the word vectors, via the steps S222 and S224, the list of the similarities is generated by rearranging the calculated similarities in the sequence of higher similarities, and the generated list of the similarities is displayed on the display unit 42.

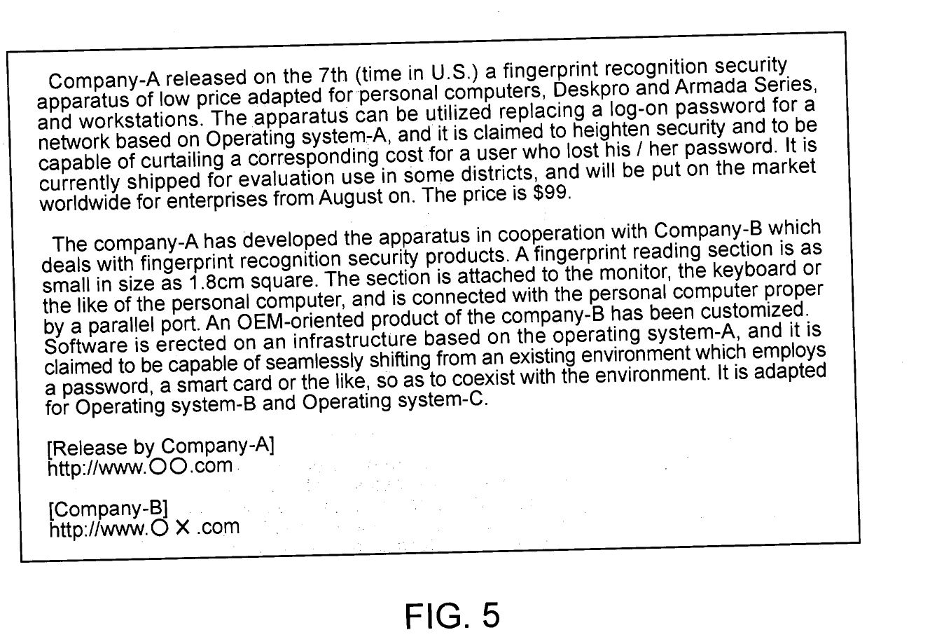

Next, an example of the present invention will be described with reference to FIG. 5 through FIG. 8.

It is assumed that document data of contents shown in FIG. 5 be held registered in the document data registration DB 44. In this example, there will be exemplified the simplest case where only one document data is held registered. FIG. 5 shows a sample of the document data.

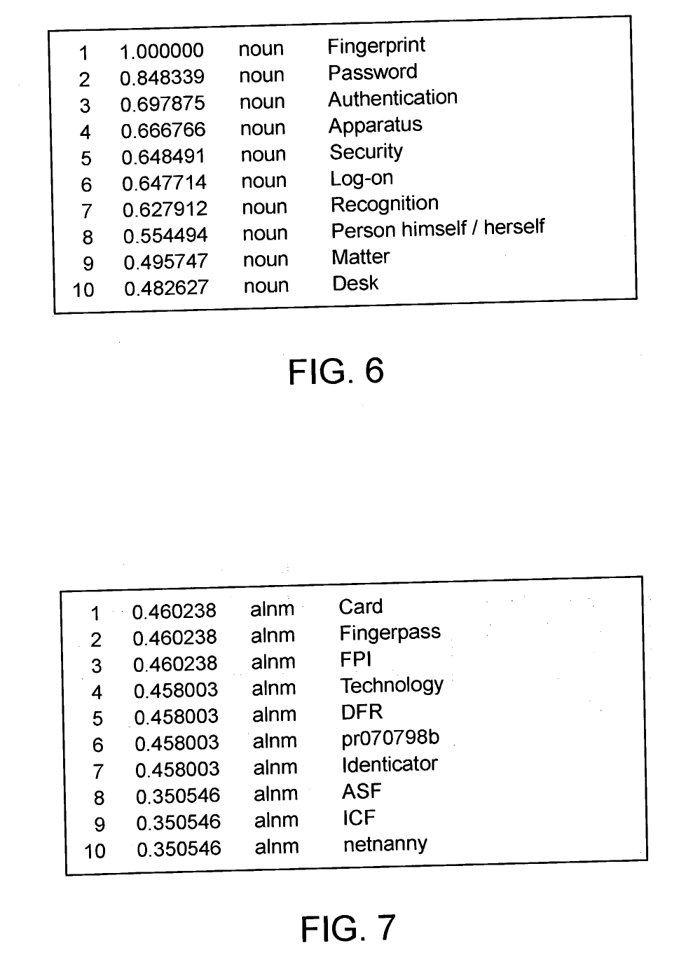

In the first place, in a case where a user has inputted “fingerprint” as a retrieval keyword and designated noun as a part of speech, the list of words whose similarities to the retrieval keyword “fingerprint” are high is displayed as shown in FIG. 6. In the list, the words are displayed in the sequence of higher similarities. FIG. 6 shows the list of the words whose similarities to the retrieval keyword “fingerprint” are high.

In the exemplary display of FIG. 6, “1 1.000000 noun Fingerprint” is registered at the first stage, and this indicates that the similarity of the word “fingerprint” to the retrieval keyword is “1.000000” and is the highest. Besides, “2 0.848339 noun Password” is registered at the second stage, and this indicates that the similarity of the word “Password” to the retrieval keyword is “0.848339” and is the second highest. Incidentally, “noun” indicates that the part of speech is the noun.

Secondly, in a case where a user has inputted “fingerprint” as a retrieval keyword and designated the alphanumeric type as a word type, the list of English words whose similarities to the retrieval keyword “fingerprint” are high is displayed as shown in FIG. 7. In the list, the English words are displayed in the sequence of higher similarities. FIG. 7 shows the list of the English words whose similarities to the retrieval keyword “fingerprint” are high.

In the exemplary display of FIG. 7, “1 0.460238 alnm Card” is registered at the first stage, and this indicates that the similarity of the word “Card” to the retrieval keyword is “0.460238” and is the highest. Besides, “4 0.458003 alnm Technology” is registered at the fourth stage, and this indicates that the similarity of the word “Technology” to the retrieval keyword is “0.458003” and is the second highest. Incidentally, “almn” indicates that the word type is the alphanumeric type.

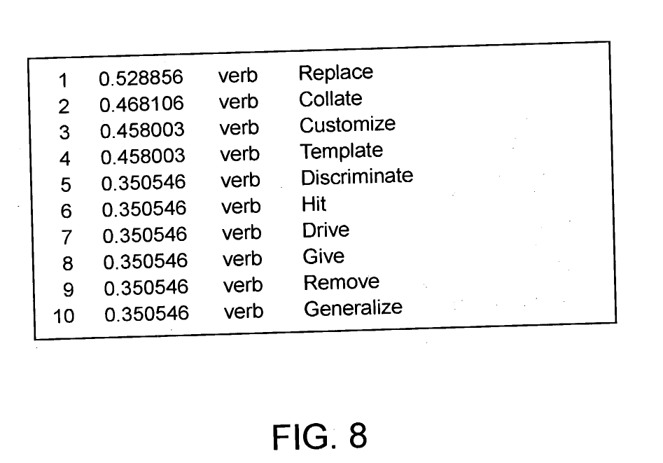

Thirdly, in a case where the user has inputted “fingerprint” as a retrieval keyword and designated verb as a part of speech, the list of words whose similarities to the retrieval keyword “fingerprint” are high is displayed as shown in FIG. 8. In the list, the words are displayed in the sequence of higher similarities. FIG. 8 shows the list of the words whose similarities to the retrieval keyword “fingerprint” are high.

In the exemplary display of FIG. 8, “1 0.528856 verb Replace” is registered at the first stage, and this indicates that the similarity of the word “Replace” to the retrieval keyword is “0.528856” and is the highest. Besides, “2 0.468106 verb Collate” is registered at the second stage, and this indicates that the similarity of the word “Collate” to the retrieval keyword is “0.468106” and is the second highest. Incidentally, “verb” indicates that the part of speech is the verb.

In this way, in this embodiment, each word vector is generated on the basis of a plurality of document data. The word vector has elements corresponding to the respective document data, and each of the elements is calculated so as to become a value which is proportional to the frequency of occurrences of a morpheme in the corresponding one of the plurality of document data and which is inversely proportional to the frequency of occurrences of the morpheme in the plurality of document data.

Thus, the word vector is generated so that each element thereof may become the value conforming the degree of importance based on the frequency of occurrences of the morpheme in the corresponding document data, so that both the morpheme of high frequency of occurrences and the morpheme of low frequency occurrences can have their degrees of importance reflected on the calculation of similarities. Accordingly, the embodiment can calculate the similarities more effectively as compared with the prior art.

Further, in this embodiment, document vectors are generated for the respective document data, the word vectors are generated on the basis of the generated document vectors, and each of the document vectors has elements which correspond to the respective morphemes and each of which is calculated so as to become a value conforming to the frequency of occurrences of the corresponding morpheme.

Thus, the embodiment has the structure of generating each word vector from the document vectors, so that use can be made of a document vector generation device in the prior art. Accordingly, the generation of the word vector becomes comparatively easy, and in turn, the similarity can be calculated comparatively easily.

Further, in this embodiment, all the document data of the document data registration DB 44 are analyzed by a morpheme analysis, the frequencies of occurrences of respective morphemes obtained by the morpheme analysis are calculated in each of the document data, a vector having elements whose values conform to the calculated frequencies of occurrences is generated as the document vector, and such document vectors are generated for all the document data of the document data registration DB 44. Thus, the word vectors can be generated merely by storing the document data in the document data registration DB 44 beforehand, so that the generation of the word vectors becomes still easier, and in turn, the similarities can be calculated more easily.

Further, in this embodiment, all the generated document vectors are gathered so as to form a document word matrix in which document vector components are taken in a row direction, components in the column direction of the document word matrix are extracted from the document word matrix, and a vector having the extracted components is generated as the word vector. Thus, the word vectors can be generated by the transposed matrix of the document word matrix, so that the generation of the word vectors becomes still easier, and in turn, the similarities can be calculated more easily.

Further, in this embodiment, the word vector concerning the same morpheme as a retrieval keyword is read out from the document data registration DB 44, and it is generated as a retrieval key word vector. Thus, the word vector can be generated from the retrieval keyword comparatively easily.

Further, in this embodiment, the word vectors concerning the same morpheme as the retrieval keyword are read out from the document data registration DB 44, they are used for generating a retrieval key word vector, the word vectors corresponding to an inputted part of speech are read out from the document data registration DB 44, and the similarities are calculated on the basis of the read-out word vectors and the generated retrieval key word vector. Thus, words to be handled can be refined by the part of speech, so that the similarities can be calculated comparatively fast and efficiently.

Incidentally, the above embodiment is constructed so that all the document data are analyzed by a morpheme analysis, that the frequency of occurrences of each of morphemes obtained by the morpheme analysis is calculated in the document data read out, and that the document vector is generated on the basis of the calculated frequencies of occurrences. However, it should be understood that the present invention is not restricted to the embodiment, but it can also be constructed so as not to make the morpheme analysis, in such a way that each document data is formed beforehand so as to include the analytical result of morphemes contained in the document data or to consist of a single morpheme. In this case, it is also allowed that the frequency of occurrences of each of the morphemes contained in the document data be calculated in the document data read out, and that a document vector is generated on the basis of the calculated frequencies of occurrences.

Thus, word vectors can be generated merely by storing the document data in the document data registration DB 44 beforehand, and the document data need not be analyzed by a morpheme analysis, so that the generation of the word vectors can be more facilitated.

Besides, the above embodiment is constructed so that the retrieval keyword is inputted, and that the word vector is generated on the basis of the inputted retrieval keyword. However, the present invention is not restricted to the embodiment, but it can also be constructed so as to input a retrieval keyword which consists of a plurality of words. In this case, the retrieval keyword consisting of the plurality of words is inputted, the inputted retrieval keyword is analyzed by a morpheme analysis, and a word vector is generated on the basis of respective morphemes obtained by the morpheme analysis. The generation of the word vector can be performed in accordance with the same point as in the case where, at the step S214 of the above embodiment, a plurality of corresponding word vectors exist in the document data registration DB 44.

Besides, in the above embodiment, it has been described that the control programs stored in the ROM 32 beforehand are run in both the cases of executing the processes shown in the flow charts of FIG. 2 and FIG. 4. However, it should be understood that the present invention is not restricted to the embodiment, but the programs indicating the steps of the processes may well be run after being loaded into the RAM 34 from a storage medium storing these programs.

Here, the storage medium can cover any storage medium which is readable by a computer irrespective of a reading method such as an electronic, magnetic, or optical method, and which includes a semiconductor storage medium such as RAM or ROM, a magnetic memory type storage medium such as FD or HD, an optical reading scheme storage medium such as CD, CDV, LD, or DVD, or a magnetic memory type/optical reading scheme storage medium such as MO.

Besides, in the above embodiment, the specified element vector generation device, character string vector generation device, similarity calculation device, specified element vector generation program, character string vector generation program, similarity calculation program, specified element vector generation method, character string vector generation method, and similarity calculation method according to the present invention have been applied to the case where, as shown in FIG. 1, the similarities to all kinds of words contained in the plurality of document data are respectively calculated concerning the retrieval keyword inputted by the user, by the computer 100. However, it should be understood that the present invention is not restricted to the embodiment, but it is also applicable to other cases within a scope not departing from the purport thereof. By way of example, the present invention can also be applied as part of a retrieval service in which similarities to all kinds of words contained in a plurality of document data are respectively calculated for a retrieval keyword inputted by a user, so as to perform retrieval in the Internet or any other network.

As described above, in accordance with a specified element vector generation device according to the present invention, a specified element vector is generated so that each of the elements thereof may become a value which is proportional to the frequency of occurrences of a specified element in corresponding data and which is inversely proportional to the frequency of occurrences of the specified element in a plurality of data. Therefore, even if any specified element of high frequency of occurrences exists, any specified element of low frequency of occurrences can be reflected on the calculation of a similarity in conformity with its frequency of occurrences. Accordingly, in case of employing the specified element vector for the calculation of the similarity, there is obtained the advantage that the similarity of the specified element can be calculated more effectively than in the prior art.

Meanwhile, in accordance with a character string vector generation device according to the present invention, a character string vector is generated so that each of the elements thereof may become a value which is proportional to the frequency of occurrences of a specified character string in corresponding document data and which is inversely proportional to the frequency of occurrences of the specified character string in a plurality of document data. Therefore, even if any specified character string of high frequency of occurrences exists, any specified character string of low frequency of occurrences can be reflected on the calculation of a similarity in conformity with its frequency of occurrences. Accordingly, in case of employing the character string vector for the calculation of the similarity, there is obtained the advantage that the similarity of the specified character string can be calculated more effectively than in the prior art.

Further, in accordance with the character string vector generation device according to the present invention, owing to structure in which the character string vector is generated from document vectors, use can be made of a prior-art document vector generation device. Accordingly, there is also obtained the advantage that the generation of the character string vector can be performed comparatively easily.

Further, in accordance with the character string vector generation device according to the present invention, the character string vector can be generated merely by storing the document data in the document data storage device beforehand, and hence, there is also obtained the advantage that the generation of the character string vector can be performed more easily.

Further, in accordance with the character string vector generation device according to the present invention, the character string vector can be generated merely by storing the document data in the document data storage device beforehand, and the document data need not be subjected to the character string analysis. Accordingly, there is also obtained the advantage that the generation of the character string vector can be performed more easily.

Further, in accordance with the character string vector generation device according to the present invention, the character string vector can be generated using the transposed matrix of a document word matrix, and hence, there is also obtained the advantage that the generation of the character string vector can be performed more easily.

Meanwhile, in accordance with a similarity calculation device according to the present invention, a specified element vector is generated so that each of the elements thereof may become a value which is proportional to the frequency of occurrences of a specified element in corresponding data and which is inversely proportional to the frequency of occurrences of the specified element in a plurality of data. Therefore, even if any specified element of high frequency of occurrences exists, any specified element of low frequency of occurrences can be reflected on the calculation of a similarity in conformity with its frequency of occurrences. Accordingly, there is obtained the advantage that the similarity of the specified element can be calculated more effectively than in the prior art.

Further, in accordance with a similarity calculation device according to the present invention, a character string vector is generated so that each of the elements thereof may become a value which is proportional to the frequency of occurrences of a specified character string in corresponding document data and which is inversely proportional to the frequency of occurrences of the specified character string in a plurality of document data. Therefore, even if any specified character string of high frequency of occurrences exists, any specified character string of low frequency of occurrences can be reflected on the calculation of a similarity in conformity with its frequency of occurrences. Accordingly, there is obtained the advantage that the similarity of the specified character string can be calculated more effectively than in the prior art.

Further, in accordance with a similarity calculation device according to the present invention, there is also obtained the advantage that a character string vector can be generated from data-for-decision comparatively easily.

Further, in accordance with a similarity calculation device according to the present invention, character string vectors to be handled can be refined by a classification attribute, and hence, there is also obtained the advantage that a similarity can be calculated comparatively fast and efficiently.

Further, in accordance with the similarity calculation device according to the present invention, character string vectors to be handled can be refined by a part of speech, and hence, there is also obtained the advantage that a similarity can be calculated comparatively fast and efficiently.

Meanwhile, in accordance with a specified element vector generation program according to the present invention, an advantage equivalent to that of the specified element vector generation device as defined in above can be obtained.

Meanwhile, in accordance with a character string vector generation program according to the present invention, an advantage equivalent to that of the character string vector generation device as defined above can be obtained.

Meanwhile, in accordance with a similarity calculation program according to the present invention, an advantage equivalent to that of the similarity calculation device as defined above can be obtained.

Further, in accordance with a similarity calculation program according to the present invention, an advantage equivalent to that of the similarity calculation device as defined above can be obtained.

Further, in accordance with a similarity calculation program as defined in claim 29 according to the present invention, an advantage equivalent to that of the specified element vector generation program as defined in claim 17 is obtained.

Further, in accordance with a similarity calculation program as defined in claim 30 according to the present invention, an advantage equivalent to that of the character string vector generation program as defined in claim 18 is obtained.

Meanwhile, in accordance with a specified element vector generation method according to the present invention, an advantage equivalent to that of the specified element vector generation device as defined above can be obtained.

Meanwhile, in accordance with a character string vector generation method according to the present invention, an advantage equivalent to that of the character string vector generation device as defined above can be obtained.

Meanwhile, in accordance with a similarity calculation method according to the present invention, an advantage equivalent to that of the similarity calculation device as defined above can be obtained.

Further, in accordance with a similarity calculation method according to the present invention, an advantage equivalent to that of the similarity calculation device as defined above can be obtained.

Further, in accordance with a similarity calculation method according to the present invention, an advantage equivalent to that of the specified element vector generation program as defined above can be obtained.

Further, in accordance with a similarity calculation method according to the present invention, an advantage equivalent to that of the character string vector generation program as defined above can be obtained.

What is claimed is:

1. A specified element vector generation device that generates a specified element vector indicating a feature of a specified element on the basis of a plurality of data, comprising:
a specified element vector generation component that generates the specified element vector on the basis of the plurality of data;
said specified element vector having elements corresponding to the respective data, and each of said elements having a value which is proportional to a frequency of occurrences of said specified element in the corresponding one of said plurality of data and which is inversely proportional to a frequency of occurrences of said specified element in said plurality of data.

2. A character string vector generation device that generates a character string vector indicating a feature of a specified character string on the basis of a plurality of document data, comprising:
a character string vector generation component that generates the character string vector on the basis of the plurality of document data;
said character string vector having elements corresponding to the respective document data, and each of said elements having a value which is proportional to a frequency of occurrences of said specified character string in the corresponding one of said plurality of document data and which is inversely proportional to a frequency of occurrences of said specified character string in said plurality of document data.

3. The character string vector generation device according to claim 2, said specified character string being at least one of a morpheme obtained by a morpheme analysis and a character string extracted in accordance with a predetermined rule.

4. The character string vector generation device according to claim 2, further comprising:
a document vector generation component that generates document vectors for the respective document data;
said document vector having at least one element corresponding to said specified character string, and said element having a value which is proportional to the frequency of occurrences of said specified character string in said document data and which is inversely proportional to the frequency of occurrences of said specified character string in said plurality of document data; and
said character string vector generation component generating said character string vector on the basis of the document vectors generated by said document vector generation device.

5. A character string vector generation device according to claim 4, further comprising:
a document data storage component that stores said plurality of document data; and
a character string analysis component that subjects the document data of said document data storage component to a character string analysis;
said document vector generation component calculating every character string obtained by the analysis of said character string analysis device, a first frequency of occurrences of the pertinent character string in said document data and a second frequency of occurrences of said pertinent character string in said plurality of document data, generating as said document vector, a vector which has an element of a value being proportional to the calculated first frequency of occurrences and being inversely proportional to the calculated second frequency of occurrences, and generating said document vector for all the document data of said document data storage component.

6. The character string vector generation device according to claim 4, further comprising:
a document data storage component that stores said plurality of document data;
wherein said document data including an analytical result of character strings contained in said document data or consists of a single character string; and
said document vector generation component calculating every character contained in said document data, a first frequency of occurrences of the pertinent character string in said document data and a second frequency of occurrences of said pertinent character string in said plurality of document data, generating as said document vector, a vector which has an element of a value being proportional to the calculated first frequency of occurrences and being inversely proportional to the calculated second frequency of occurrences, and generating said document vector for all the document data of said document data storage component.

7. The character string vector generation device according to claim 5, said character string vector generation component forming a document word matrix in which the document vectors generated by said document vector generation device are gathered so as to set components of said document vectors as either of rows and columns, the character string vector generation component extracting components of the other of the rows and columns of the document word matrix from said document word matrix, and the character string vector generation device generating a vector of the extracted components as said character string vector.

8. A character string vector generation device according to claim 2, further comprising:
a character string vector storage component that stores said character string vectors;
said character string vector generation component storing the generated character string vector in said character string vector storage device.

9. A similarity calculation device calculates a similarity to a specified element on the basis of a specified element vector indicating a feature of the specified element, comprising:
a specified element vector storage component that stores said specified element vector;
a data-for-decision input component that inputs data-for-decision containing a specified element for similarity decision;
a specified element vector generation component that generates said specified element vector on the basis of the data-for-decision inputted by said data-for-decision input component; and
a similarity calculation component that calculates said similarity on the basis of said specified element vector generated by said specified element vector generation component and said specified element vector of said specified element vector storage component;
said specified element vector having elements corresponding to the respective plurality of data, and each of said elements having a value which is proportional to a frequency of occurrences of said specified element in the corresponding one of said plurality of data and which is inversely proportional to a frequency of occurrences of said specified element in said plurality of data.

10. A similarity calculation device that calculates a similarity to a specified character string on the basis of a character string vector indicating a feature of the specified character string, comprising:
a character string vector storage component that stores the character string vector;
a data-for-decision input component that inputs data-for-decision containing a specified character string for similarity decision;
a character string vector generation component that generates said character string vector on the basis of the data-for-decision inputted by said data-for-decision input device; and
a similarity calculation component that calculates said similarity on the basis of the character string vector generated by said character string vector generation component and the character string vector of said character string vector storage component,
said character string vector having elements corresponding to the respective plurality of document data, and each of said elements having a value which is proportional to a frequency of occurrences of said specified character string in the corresponding one of said plurality of document data and which is inversely proportional to a frequency of occurrences of said specified character string in said plurality of document data.

11. The similarity calculation device according to claim 10, said specified character string being at least one of a morpheme obtained by a morpheme analysis and a character string extracted in accordance with a predetermined rule.

12. The similarity calculation device according to claim 10, said character string vector generation component reads out a character string vector concerning the same character string as the specified character string contained in said data-for-decision, from said character string vector storage component.

13. The similarity calculation device according to claim 12, wherein, when a plurality of the character string vectors concerning the same character string as the specified character string contained in said data-for-decision exist in said character string vector storage component, said character string vector generation component reads out the character string vectors from said character string vector storage component and then generates the single character string vector on the basis of said character string vectors read out.

14. The similarity calculation device according to claim 13, said character string vector generation component reads out the character string vector concerning the same character string as the specified character string contained in said data-for-decision, from said character string vector storage component, calculates average values of elements of the same dimensions as to the character string vectors read out, and generates the character string vector which has the calculated average values as values of its elements, respectively.

15. The similarity calculation device according to claim 10, said character string vector storage component said character string vector in association with a classification attribute of a pertinent word;
said data-for-decision input component inputting said data-for-decision and the classification attribute;
said character string vector generation component reading out the character string vector concerning the same character string as the specified character string contained in said data-for-decision, from said character string vector storage device; and
said similarity calculation component reading out the character string vector corresponding to the classification attribute inputted by said data-for-decision input component, from said character string vector storage component, and then calculates the similarity on the basis of the read-out character string vector and the character string vector generated by said character string vector generation component.

16. The similarity calculation device according to claim 15, said classification attribute a part of speech.

17. A similarity calculation device that calculates a specified element vector indicating a feature of a specified element is generated on the basis of a plurality of data, and a similarity to said specified element on the basis of said specified element vector, comprising:
a first specified element vector generation component that generates said specified element vector on the basis of said plurality of data;
a specified element vector storage component that stores the specified element vector generated by said first specified element vector generation component;
a data-for-decision input component that inputs data-for-decision containing a specified element for similarity decision;
a second specified element vector generation component that generates said specified element vector on the basis of the data-for-decision inputted by said data-for-decision input component; and
a similarity calculation component that calculates said similarity on the basis of the specified element vector generated by said second specified element vector generation component and the specified element vector of said specified element vector storage component,
said specified element vector having elements corresponding to the respective data, and each of the elements having a value which is proportional to a frequency of occurrences of the specified element in the corresponding one of said plurality of data and which is inversely proportional to a frequency of occurrences of said specified element in said plurality of data.

18. A similarity calculation device that calculates a character string vector indicating a feature of a specified character string is generated on the basis of a plurality of document data, and a similarity to said specified character string on the basis of said character string vector, comprising:
a first character string vector generation component that generates said character string vector on the basis of said plurality of document data;
a character string vector storage component that stores the character string vector generated by said first character string vector generation component;
a data-for-decision input component that inputs data-for-decision containing a specified character string for similarity decision;
a second character string vector generation component that generates said character string vector on the basis of the data-for-decision inputted by said data-for-decision input component; and
a similarity calculation component that calculates said similarity on the basis of the character string vector generated by said second character string vector generation component and the character string vector of said character string vector storage component;
said character string vector having elements corresponding to said respective document data, and each of said elements having a value which is proportional to a frequency of occurrences of said specified character string in the corresponding one of said plurality of document data and which is inversely proportional to a frequency of occurrences of said specified character string in said plurality of document data.

19. The similarity calculation device according to claim 18, said specified character string being at least one of a morpheme obtained by a morpheme analysis and a character string extracted in accordance with a predetermined rule.

20. The similarity calculation device according to claim 18, said second character string vector generation component reads out a character string vector concerning the same character string as the specified character string contained in said data-for-decision, from said character string vector storage component.

21. The similarity calculation device according to claim 20, wherein, when a plurality of the character string vectors concerning the same character string as the specified character string contained in said data-for-decision exist in said character string vector storage component, said second character string vector generation component reads out the character string vectors from said character string vector storage component, and then generates the single character string vector on the basis of said character string vectors read out.

22. The similarity calculation device according to claim 21, said second character string vector generation component reading out the character string vectors concerning the same character string as the specified character string contained in said data-for-decision, from said character string vector storage component, calculating average values of elements of the same dimensions as to the character string vectors read out, and generating the character string vector which has the calculated average values as values of its elements, respectively.

23. The similarity calculation device according to claim 18, said character string vector storage component storing said character string vector in association with a classification attribute of a pertinent word;
said data-for-decision input component inputting said data-for-decision and the classification attribute;
said second character string vector generation component reading out the character string vector concerning the same character string as the specified character string contained in said data-for-decision, from said character string vector storage component; and
said similarity calculation component reading out the character string vector corresponding to the classification attribute inputted by said data-for-decision input component, from said character string vector storage component, and then calculating said similarity on the basis of the read-out character string vector and the character string vector generated by said character string vector generation component.

24. A similarity calculation device according to claim 23, said classification attribute being a part of speech.

25. A program wherein a specified element vector indicating a feature of a specified element is generated on the basis of a plurality of data, comprising:
a specified element vector generation program that causes a computer to execute a process which is implemented as a specified element vector generation component that generates said specified element vector on the basis of said plurality of data;
said specified element vector having elements corresponding to said respective data, and each of said elements having a value which is proportional to a frequency of occurrences of said specified element in the corresponding one of said plurality of data and which is inversely proportional to a frequency of occurrences of said specified element in said plurality of data.

26. A program wherein a character string vector indicating a feature of a specified character string is generated on the basis of a plurality of document data, comprising:
a character string vector generation program that causes a computer to execute a process which is implemented as a character string vector generation component that generates said character string vector on the basis of said plurality of document data;
said character string vector having elements corresponding to said respective document data, and each of said elements having a value which is proportional to a frequency of occurrences of said specified character string in the corresponding one of said plurality of document data and which is inversely proportional to a frequency of occurrences of said specified character string in said plurality of document data.

27. A program wherein a similarity to a specified element is calculated on the basis of a specified element vector indicating a feature of the specified element, comprising:
a similarity calculation program that causes a computer, which can utilize specified element vector storage component that stores said specified element vector, and data-for-decision input component that inputs data-for-decision containing a specified element for similarity decision to execute a process which is implemented as a specified element vector generation component that generates said specified element vector on the basis of the data-for-decision inputted by said data-for-decision input component, and a similarity calculation component that calculates said similarity on the basis of the specified element vector generated by said specified element vector generation component and the specified element vector of said specified element vector storage component;
said specified element vector having elements corresponding to the respective data, and each of said elements having a value which is proportional to a frequency of occurrences of said specified element in the corresponding one of said plurality of data and which is inversely proportional to a frequency of occurrences of said specified element in said plurality of data.

28. A program wherein a similarity to a specified character string is calculated on the basis of a character string vector indicating a feature of the specified character string, comprising:
a similarity calculation program a computer, which can utilize a character string vector storage component that stores said character string vector, and a data-for-decision input component that inputs data-for-decision containing a specified character string for similarity decision to execute a process which is implemented as a character string vector generation component that generates said character string vector on the basis of the data-for-decision inputted by said data-for-decision input device, and a similarity calculation component that calculates said similarity on the basis of the character string vector generated by said character string vector generation component and the character string vector of said character string vector storage component;
said character string vector having elements corresponding to the respective document data, and each of said elements having a value which is proportional to a frequency of occurrences of said specified character string in the corresponding one of said plurality of document data and which is inversely proportional to a frequency of occurrences of said specified character string in said plurality of document data.

29. A program wherein a specified element vector indicating a feature of a specified element is generated on the basis of a plurality of data, and a similarity to said specified element is calculated on the basis of said specified element vector, comprising:
a similarity calculation program that causes a computer, which can utilize a specified element vector storage component that stores said specified element vector, and a data-for-decision input component that inputs data-for-decision containing a specified element for similarity decision to execute a process which is implemented as first specified element vector generation component that generates said specified element vector on the basis of said plurality of data and then storing the generated vector in the specified element vector storage component, a second specified element vector generation component that generates said specified element vector on the basis of the data-for-decision inputted by said data-for-decision input component, and a similarity calculation component that calculates said similarity on the basis of the specified element vector generated by said second specified element vector generation component and the specified element vector of said specified element vector storage component;
said specified element vector having elements corresponding to said respective data, and each of said elements having a value which is proportional to a frequency of occurrences of said specified element in the corresponding one of said plurality of data and which is inversely proportional to a frequency of occurrences of said specified element in said plurality of data.

30. A program wherein a character string vector indicating a feature of a specified character string is generated on the basis of a plurality of document data, and a similarity to said specified character string is calculated on the basis of said character string vector, comprising:
a similarity calculation program that causes a computer, which can utilize a character string vector storage component that stores said character string vector, and a data-for-decision input component that inputs data-for-decision containing a specified character string for similarity decision to execute a process which is implemented as first character string vector generation component that generates said character string vector on the basis of said plurality of document data and then storing the generated vector in said character string vector storage component, a second character string vector generation component that generates said character string vector on the basis of the data-for-decision inputted by said data-for-decision input component, and similarity calculation component that calculates said similarity on the basis of the character string vector generated by said second character string vector generation component and the character string vector of said character string vector storage component;
said character string vector having elements corresponding to said respective document data, and each of said elements having a value which is proportional to a frequency of occurrences of said specified character string in the corresponding one of said plurality of document data and which is inversely proportional to a frequency of occurrences of said character string in said plurality of document data.

31. A specified element vector generation method that generates a specified element vector indicating a feature of a specified element on the basis of a plurality of data, comprising:
a specified element vector generation step of generating said specified element vector on the basis of said plurality of data;
said specified element vector having elements corresponding to said respective data, and each of said elements having a value which is proportional to a frequency of occurrences of said specified element in the corresponding one of said plurality of data and which is inversely proportional to a frequency of occurrences of said specified element in said plurality of data.

32. A character string vector generation method that generates a specified element vector indicating a feature of a specified element on the basis of a plurality of document data, comprising:
a character string vector generation step of generating said character string vector on the basis of said plurality of document data;
said character string vector having elements corresponding to said respective document data, and each of said elements having a value which is proportional to a frequency of occurrences of said specified character string in the corresponding one of said plurality of document data and which is inversely proportional to a frequency of occurrences of said specified character string in said plurality of document data.

33. A similarity calculation method that calculates, a similarity to a specified element on the basis of a specified element vector indicating a feature of the specified element, comprising:
a specified element vector storage step of storing said specified element vector in a specified element vector storage component;
a data-for-decision input step of inputting data-for-decision containing a specified element for similarity decision;
a specified element vector generation step of generating said specified element vector on the basis of the data-for-decision inputted at said data-for-decision input step; and
a similarity calculation step of calculating said similarity on the basis of the specified element vector generated at said specified element vector generation step and the specified element vector of said specified element vector storage component;
said specified element vector having elements corresponding to the respective data, and each of said elements having a value which is proportional to a frequency of occurrences of said specified element in the corresponding one of said plurality of data and which is inversely proportional to a frequency of occurrences of said specified element in said plurality of data.

34. A similarity calculation method that calculates a similarity to a specified character string on the basis of a specified character vector indicating a feature of the specified character string, comprising:
a character string vector storage step of storing said character string vector in the character string vector storage component;
a data-for-decision input step of inputting data-for-decision containing a specified character string for similarity decision;
a character string vector generation step of generating said character string vector on the basis of the data-for-decision inputted at said data-for-decision input step; and
a similarity calculation step of calculating said similarity on the basis of the character string vector generated at said character string vector generation step and the character string vector of said character string vector storage component;
said character string vector having elements corresponding to the respective document data, and each of said elements having a value which is proportional to a frequency of occurrences of said specified character string in the corresponding one of said plurality of document data and which is inversely proportional to a frequency of occurrences of said specified character string in said plurality of document data.

35. A similarity calculation method that generates a specified element vector indicating a feature of a specified element on the basis of a plurality of data, and a similarity to said specified element is calculated on the basis of said specified element vector, comprising:
a first specified element vector generation step of generating said specified element vector on the basis of said plurality of data;
a specified element vector storage step of storing the specified element vector generated at said first specified element vector generation step, in a specified element storage component;
a data-for-decision input step of inputting data-for-decision containing a specified element for similarity decision;
a second specified element vector generation step of generating said specified element vector on the basis of the data-for-decision inputted at said data-for-decision input step; and
a similarity calculation step of calculating said similarity on the basis of the specified element vector generated at said second specified element vector generation step and the specified element vector of said specified element vector storage component;
said specified element vector having elements corresponding to said respective data, and each of said elements having a value which is proportional to a frequency of occurrences of said specified element in the corresponding one of said plurality of data and which is inversely proportional to a frequency of occurrences of said specified element in said plurality of data.

36. A similarity calculation method that generates a character string vector indicating a feature of a specified character string on the basis of a plurality of document data, and a similarity to said specified character string is calculated on the basis of said character string vector, comprising:
a first character string vector generation step of generating said character string vector on the basis of said plurality of document data;
a character string vector storage step of storing the character string vector generated at said first character string vector generation step, in a character string vector storage component;
a data-for-decision input step of inputting data-for-decision containing a specified character string for similarity decision;
a second character string vector generation step of generating said character string vector on the basis of the data-for-decision inputted at said data-for-decision input step; and
a similarity calculation step of calculating said similarity on the basis of the character string vector generated at said second character string vector generation step and the character string vector of said character string vector storage component;
said character string vector having elements corresponding to said respective document data, and each of said elements having a value which is proportional to a frequency of occurrences of said specified character string in the corresponding one of said plurality of document data and which is inversely proportional to a frequency of occurrences of said specified character string in said plurality of document data.
